(19) United States
(12) Patent Application Publication
(10) Pub. No.: US 2022/0383166 A1
(43) Pub. Date: Dec. 1, 2022

(54) OPTIMIZING RESERVOIR COMPUTERS FOR HARDWARE IMPLEMENTATION

(71) Applicant: Ohio State Innovation Foundation, Columbus, OH (US)

(72) Inventors: Aaron GRIFFITH, Reynoldsburg, OH (US); Daniel GAUTHIER, Hilliard, OH (US)

(21) Appl. No.: 17/765,895

(22) PCT Filed: Sep. 30, 2020
(86) PCT No.: PCT/US2020/053405

§ 371 Date: Apr. 1, 2022

Related U.S. Application Data
(60) Provisional application No. 62/908,647, filed on Oct. 1, 2019.

(51) Int. Cl. G06N 7/00

(52) U.S. Cl. CPC G06N 7/005

(57) ABSTRACT

A method of optimizing a topology for reservoir computing comprises optimizing a plurality of reservoir computer (RC) hyperparameters to generate a topology, and creating a reservoir as a network of interacting nodes with the topology. Optimizing the RC hyperparameters uses a Bayesian technique. The RC hyperparameters comprise: γ, which sets a characteristic time scale of the reservoir, σ, which determines a probability a node is connected to a reservoir input, ρᵢₙ, which sets a scale of input weights, k, a recurrent in-degree of the network, and ρᵣ, a spectral radius of the network.

### CROSS-REFERENCE TO RELATED APPLICATIONS

This application claims the benefit of U.S. provisional patent application No. 62/908,647, filed on Oct. 1, 2019, and entitled “OPTIMIZING RESERVOIR COMPUTERS FOR HARDWARE IMPLEMENTATION,” the disclosure of which is expressly incorporated herein by reference in its entirety.

### STATEMENT OF GOVERNMENT SUPPORT

This invention was made with government support under W911NF-12-1-0099 awarded by the U.S. Army Research Office. The government has certain rights in the invention.

### BACKGROUND

Reservoir computing is a neural network approach for processing time-dependent signals and has seen rapid development in recent years. In reservoir computing, the network is divided into input nodes, a bulk collection of nodes known as the reservoir, and output nodes, such that the only recurrent links are between reservoir nodes. Training involves only adjusting the weights along links connecting the reservoir to the output nodes and not the recurrent links in the reservoir. This approach displays state-of-the-art performance in a variety of time-dependent tasks, including chaotic time-series prediction, system identification and control, and spoken word recognition, all with short training times in comparison to other neural-network approaches.

A reservoir computer (RC) is a machine learning tool that has been used successfully for chaotic system forecasting and hidden-variable observation. The RC uses an internal or hidden artificial neural network (the reservoir), which is a dynamic system that reacts over time to changes in its inputs. Since the RC is a dynamical system with a characteristic time scale, it is a good fit for solving problems where time and history are critical.

Thus, RCs are well-suited for machine learning tasks that involve processing time-varying signals such as those generated by human speech, communication systems, chaotic systems, weather systems, and autonomous vehicles. Compared to other neural network techniques, RCs can be trained using less data and in much less time. They also possess a large network component (the reservoir) that can be re-used for different tasks.

RCs are useful for classifying, forecasting, and controlling dynamical systems. They can be realized in hardware on a field-programmable gate array (FPGA) to achieve world-record processing speeds. One difficulty in realizing hardware reservoirs is the topology of the network; that is, the way the nodes are connected. More particularly, reservoir computers have seen wide use in forecasting physical systems, inferring unmeasured values in systems, and classification. The construction of a reservoir computer is often reduced to a handful of tunable parameters. Choosing the best parameters for the job at hand is a difficult task.

More recently, RCs have been used to learn the climate of a chaotic system; that is, an RC learns the long-term features of the system, such as the system's attractor. Reservoir computers have also been realized physically as networks of autonomous logic on an FPGA or as optical feedback systems, both of which can perform chaotic system forecasting at a very high rate.

A common issue that must be addressed in all of these implementations is designing the internal reservoir. Commonly, the reservoir is created as a network of interacting nodes with a random topology. Many types of topologies have been investigated, from Erdös-Rényi networks and small world networks to simpler cycle and line networks. Optimizing the RC performance for a specific task is accomplished by adjusting some large-scale network properties, known as hyperparameters, while constraining others.

Choosing the correct hyperparameters is a difficult problem because the hyperparameter space can be large. There are a handful of known results for some parameters, such as setting the spectral radius pr of the network near to unity and the need for recurrent network connections, but the applicability of these results is narrow. In the absence of guiding rules, choosing the hyperparameters is done with costly optimization methods, such as grid search, or methods that only work on continuous parameters, such as gradient descent.

It is with respect to these and other considerations that the various aspects and embodiments of the present disclosure are presented.

### SUMMARY

The systems and methods described herein remove the drawbacks associated with previous systems and methods. Certain aspects of the present disclosure relate to optimization systems and methods of network topologies of reservoir computers. This greatly reduces the resources and power required to run a reservoir computer in hardware.

In an implementation, a method of optimizing a topology for reservoir computing is provided, the method comprising: optimizing a plurality of reservoir computer (RC) hyperparameters to generate a topology; and creating a reservoir as a network of interacting nodes with the topology.

In an implementation, a method for optimizing a reservoir computer is provided, the method comprising: (a) constructing a single random reservoir computing using a plurality of hyperparameters; (b) training the reservoir computer; (c) measuring a performance of the reservoir computer; (d) choosing a second plurality of hyperparameters; (e) repeating (a)-(c) with the second plurality of hyperparameters to determine a set of optimized hyperparameters; and (f) creating a reservoir using the set of optimized hyperparameters.

In an implementation, a topology for creating a reservoir as a network is provided, wherein the topology is a single line.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is block diagram of an implementation of a reservoir computing device;

FIG. 2 is an illustration of an example reservoir computing device;

FIG. 3 is an operational flow of an implementation of a method of reservoir computing;

FIG. 4 is an illustration of another example reservoir computing device;

FIG. 5 is an operational flow of another implementation of a method of reservoir computing;

FIGS. 6, 7, 8, 9, and 10 are illustrations that each show a different example reservoir topology;

FIG. 11 is block diagram of another implementation of a reservoir computing device;

FIG. 12 is an operational flow of an implementation of a method of determining hyperparameters for reservoir computing; and

FIG. 13 shows an exemplary computing environment in which example embodiments and aspects may be implemented.

### DETAILED DESCRIPTION

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In some aspects, the present invention relates to systems and techniques for optimization systems and methods of network topologies for reservoir computers (RCs). In an implementation, a reservoir computer (RC) may be used to transform one time-varying signal (the input to the RC) into another time-varying signal (the output of the RC), using the dynamics of an internal system called the reservoir.

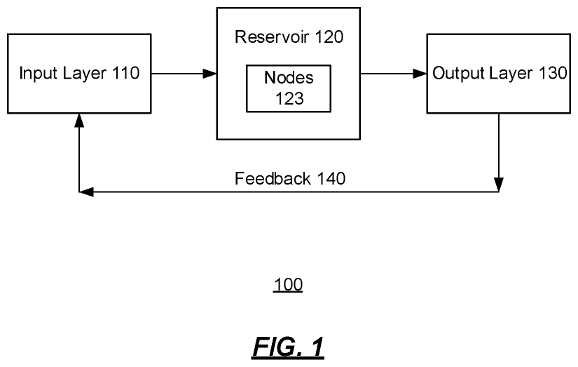

FIG. 1 is block diagram of an implementation of a reservoir computing device 100. The reservoir computing device 100 comprises an input layer 110, a reservoir 120, an output layer 130, and feedback 140. The input layer 110 provides one or more input signals (e.g., u(t)) to the reservoir 120. The input signals can be weighted using values determined during training of the reservoir computing device 100. The input layer 110 may comprise a plurality of input channels that carry input signals.

The reservoir 120 may be a recurrent artificial neural network comprising a plurality of nodes 123. The reservoir 120 may contain interconnections that couple a pair of the nodes 123 together in the reservoir 120, such that one of the nodes 123 provides its output as an input to another of the nodes 123. Each of the nodes 123 may be weighted with a real-valued weight. The nodes 123 in the reservoir 120 may implement one or more logic gates, such as Boolean logic gates, to perform various operations on input signals from the input layer 110. The input layer 110 may be coupled to some or all of the nodes 123 (e.g., an input node subset of the nodes 123) depending on the implementation. Results from the nodes 123 may be provided from the reservoir 120 to the output layer 130. The output layer 130 may be coupled to some or all of the nodes 123 (e.g., an output node subset of the nodes 123). According to some aspects, the reservoir 120 may be implemented in integrated circuitry, such as an FPGA. In an embodiment, the reservoir 120 is realized by an autonomous, time-delay, Boolean network configured on an FPGA.

The output layer 130 may receive output signals from the reservoir 120. The output layer 130 may comprise a plurality of output channels that carry output signals. Weights may be added to the output signals in the reservoir 120 before being provided to the output layer 130 (e.g., as v_{d}(t)). The weights may be determined during training of the reservoir computing device 100. Weights may also be applied to the input signals of the input layer 110 before being provided to the reservoir 120.

The feedback 140 may be comprised of feedback circuitry and/or feedback operations in which the output signal of the device 100 (i.e., the output of the output layer 130) is sent back to the input layer 110 to create feedback within the reservoir 120.

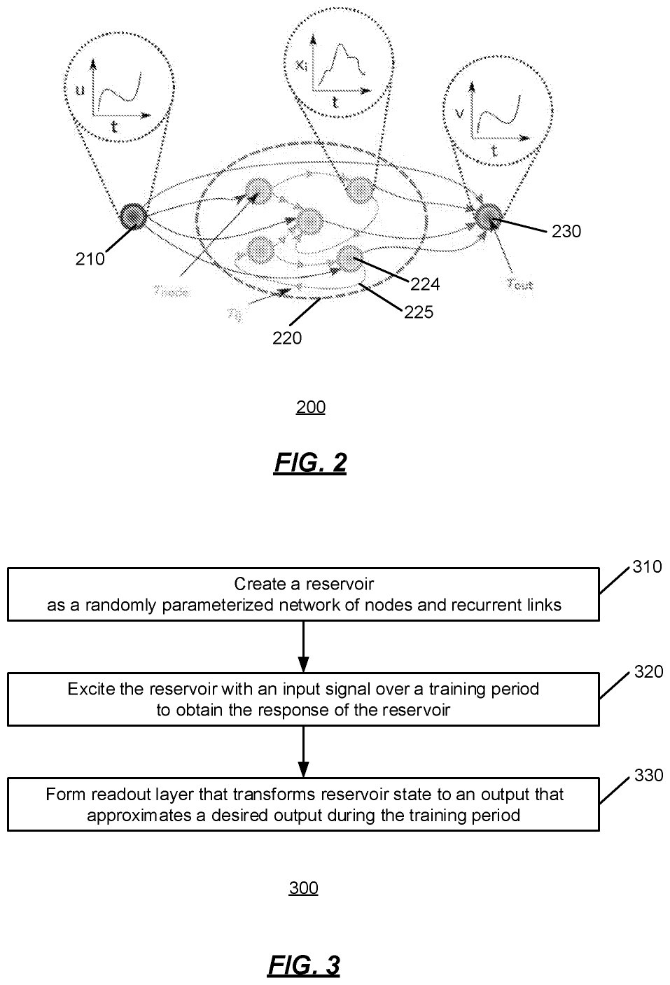

FIG. 2 is an illustration of an example reservoir computing device 200, and FIG. 3 is an operational flow of an implementation of a method 300 of reservoir computing. The device 200 comprises an input node 210 (or input layer), a reservoir 220 comprising a plurality of nodes 224, and an output node 230 (or output layer). Also shown are a plurality of links 225 between various ones of the input node 210, the nodes 224, and the output node 230. Given an input signal u(t) at the input node 210, and a desired output signal v_{d}(t) at the output node 230, a reservoir computer constructs a mapping from u(t) to v_{d}(t) with the following steps.

At 310, create a randomly parameterized network of nodes and recurrent links called the reservoir with state X(t) and dynamics described by \dot{X}(0=f[X(t),u(t)]. At 320, excite the reservoir with an input signal u(t) over some training period and observe the response of the reservoir. At 330, form a readout layer that transforms the reservoir state X(t) to an output v(t), such that v(t) well approximates v_{d}(t) during the training period. No assumptions are made about the dynamics f. In general, it may include discontinuities, time-delays, or have components simply equal to u(t) (i.e., the reservoir 220 may include a direct connection from the input 210 to the output 230).

Thus, in FIG. 2, a general reservoir computer learns to map an input onto a desired output. The network dynamics may contain propagation delays along the links (denoted by τᵢⱼ or through nodes (such as through the output layer, denoted by τₒᵤₜ).

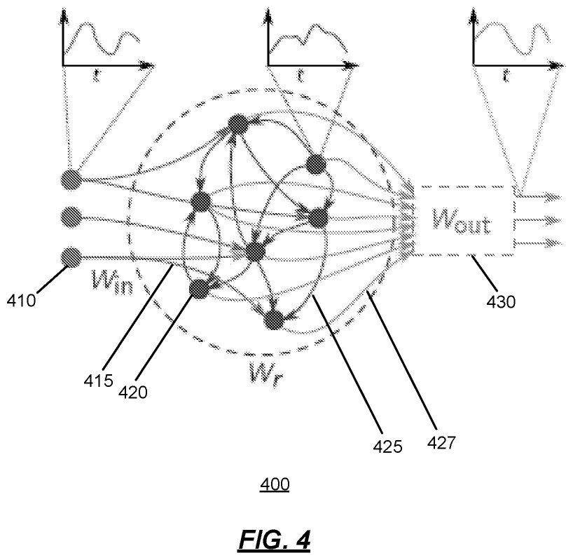

More particularly, an RC construct, known as an echo state network, is described and uses a network of nodes as the internal reservoir. Every node has inputs, drawn from other nodes in the reservoir or from the input to the RC, and every input has an associated weight. Each node also has an output, described by a differential equation. The output of each node in the network is fed into the output layer of the RC, which performs a linear operation of the node values to produce the output of the RC as a whole. This construction described with respect to FIG. 4 which is an illustration of another example reservoir computer 400.

In FIG. 4, each node may have three kinds of connections: connections 425 to other nodes 420 in the network (Wᵣ), connections 415 to the overall input 410 (Wᵢₙ), or connections 427 to the output 430 (Wₒᵤₜ). Note that the internal connections 425 may contain cycles. When the RC is used to perform forecasting, the output on the right side is connected to the input on the left side, allowing the RC to run autonomously with no external input.

With respect to the reservoir, in an implementation, the dynamics of the reservoir are described by Equation (1):

\dot{r}(t)=−γr(t)+γtanh(Wᵣr(t)+Wᵢₙu(t)) (1)

where each dimension of the vector r represents a single node in the network. Here, the function tanh(. . .) operates component-wise over vectors: tanh(x)ᵢ=tanh(xᵢ). It is noted that the function does not have to be tanh, as a wide range of nonlinear functions may be used instead of tanh.

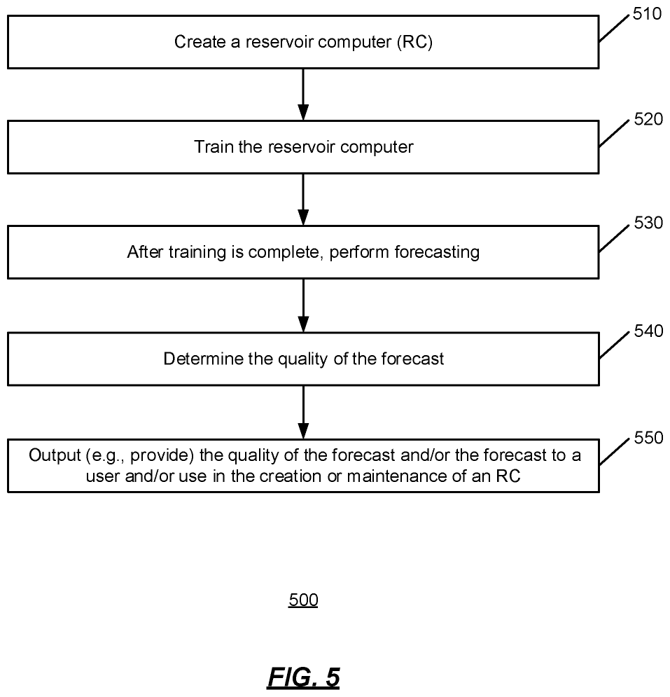

FIG. 5 is an operational flow of an implementation of a method 500 of reservoir computing. At 510, create a reservoir computer, and at 520, train the reservoir computer. In an implementation, set the dimension of the reservoir vector r at N=100 nodes, and the dimension d of the input signal u(t) is set to d=3. Therefore, Wᵣ is an N×N matrix encoding connections between nodes in the network, and Win is an N×d matrix encoding connections between the reservoir input u(t) and the nodes within the reservoir. The parameter γ defines a natural rate (inverse time scale) of the reservoir dynamics. The RC performance depends on the specific choice of γ, Wᵣ, and Wᵢₙ, as described further herein.

The output layer consists of a linear transformation of a function of node values described by Equation (2):

Y(t)=Wₒᵤₜ\tilde{r}(t) (2)

where \tilde{r}(t)=fₒᵤₜ(r(t)).

The function fₒᵤₜ is chosen ahead of time to break any unwanted symmetries in the reservoir system. If no such symmetries exist, \tilde{r}(t)=r(t) suffices. Wₒᵤₜ is chosen by supervised training of the RC. First, the reservoir structure in Equation (1) is fixed. Then, the reservoir is fed an example input u(t) for which the desired output y_{desired}(t) is known. This example input produces a reservoir response r(t) via Equation (1). Then, choose Wₒᵤₜ to minimize the difference between y(t) and y_{desired}(t), to approximate, as given by Equation (3):

Y_{desired}(t)≈Wₒᵤₜ\tilde{r}(t) (³)

Further details of how this approximation is performed are described below.

Once the reservoir computer is trained, Equations (1) and (2) describe the complete process to transform the RC's input u(t) into its output y(t).

With respect to forecasting, to forecast a signal u(t) with an RC, construct the RC, and train Wₒᵤₜ to reproduce the reservoir input u(t). Set Wₒᵤₜ to best approximate, as given by Equation (4):

u(t)≈Wₒᵤₜ\tilde{r}(t). (4)

At 530, forecasting is performed. To begin forecasting, replace the input to the RC with the output. That is, replace u(t) with Wₒᵤₜ\tilde{r}(t), and replace Equation (1) with Equation (5):

\dot{r}(t)=−γr(t)+γtanh(Wᵣr(t)+WᵢₙWₒᵤₜ\tilde{r}(t)) (5)

which no longer has a dependence on the input u(t) and runs autonomously. If Wₒᵤₜ is chosen well, then Wₒᵤₜ\tilde{r}(t) will approximate the original input u(t). At 540, determine the quality of the forecast. The two signals Wₒᵤₜ\tilde{r}(t) and u(t)) can be compared to assess the quality of the forecast. At 550, the quality of the forecast, and/or the forecast itself, may be outputted or otherwise provided to a user and/or may be used in the creation or maintenance of a reservoir computer.

Regarding reservoir construction and training, to build the reservoir computers, first build the internal network to use as the reservoir, then create connections from the nodes to the overall input, and then train it to fix Wₒᵤₜ. Once this is completed, the RC will be fully specified and able to perform forecasting.

Regarding internal reservoir construction, there are many possible choices for generating the internal reservoir connections Wᵣ and the input connections Wᵢₙ. For Wᵢₙ, randomly connect each node to each RC input with probability σ. The weight for each connection is drawn randomly from a normal distribution with mean 0 and variance ρ²ᵢₙ. Together, σ and ρᵢₙ are enough to generate a random instantiation of Wᵢₙ.

For the internal connections Wᵣ, generate a random network where every node has a fixed in-degree k. For each node, select k nodes in the network without replacement and use random weight drawn from a normal distribution with mean 0 and variance 1. This results in a connection matrix Wᵣ' where each row has exactly k non-zero entries. Finally, rescale the whole matrix as given by Equation (6):

$${W}_{r} = \frac{{ρ}_{r}}{SR ( {W}_{r}^{′} )} {W}_{r}^{′} \qquad ( 6 )$$

where SR(Wᵣ') is the spectral radius, or maximum absolute eigenvalue, of the matrix Wᵣ'. This scaling ensures that SR(Wᵣ)=ρᵣ. Together, k and ρᵣ are enough to generate a random instantiation of Wᵣ. An example of such a network is illustrated in FIG. 6.

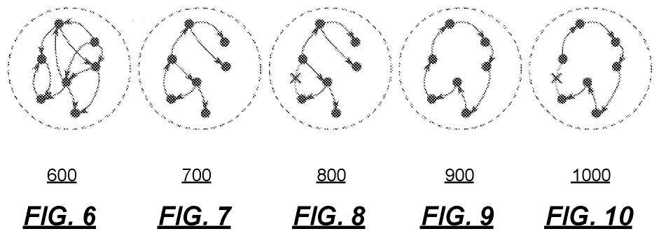

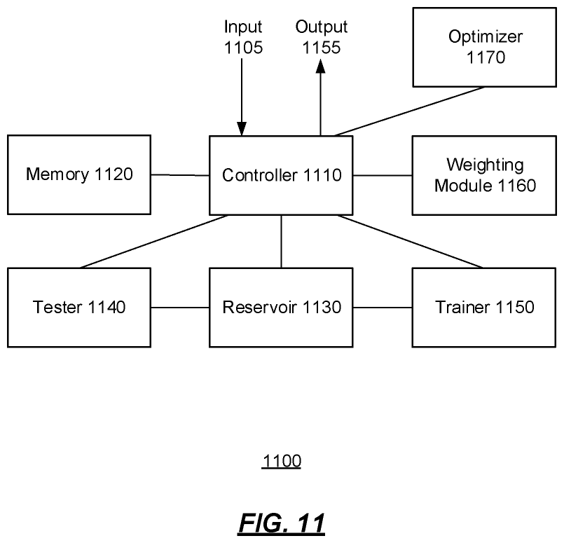

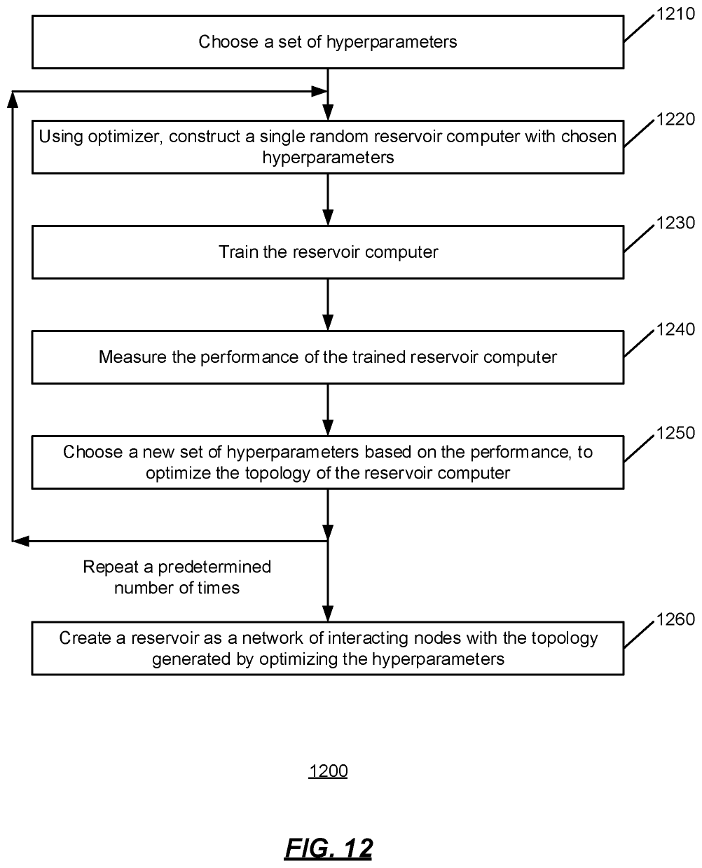

FIGS. 6-10 illustrate five example reservoir topologies, respectively. Only internal reservoir connections are shown. Connections to the reservoir computer input, or to the output layer (as in FIG. 4) are not shown. FIG. 6 shows a general, fixed in-degree network 600, here pictured with N=7 and k=2. FIG. 7 shows a k=1 network 700 with a single connected component. FIG. 8 shows a k=1 network 800 with the single cycle cut at an arbitrary point. FIG. 9 shows a simple cycle reservoir 900. FIG. 10 shows a delay line reservoir 1000.

Therefore, to create a random instantiation of a RC suitable to begin the training process, set a value for five hyperparameters:

γ, which sets the characteristic time scale of the reservoir,

σ, which determines the probability a node is connected to a reservoir input,

ρᵢₙ, which sets the scale of input weights,

k, the recurrent in-degree of the reservoir network, and

ρᵣ, the spectral radius of the reservoir network.

These parameters may be selected or determined by searching a range of acceptable values selected to minimize the forecasting error using the Bayesian optimization procedure, as described further herein. It has been determined that RCs with k=1 perform as well as RCs with a higher k.

Reservoir networks with a single connected component are contemplated herein. If a k=1 network only has a single connected component, then it also contains only a single directed cycle. This limits how recurrence can occur inside the network compared to higher-k networks. Every node in a k=1 network is either part of this cycle or part of a directed tree branching off from this cycle, as depicted in FIG. 7. Inspired by the high performance of this structure, k=1 networks are contemplated when the single cycle is cut at an arbitrary point. This turns the entire network into a tree, as in FIG. 8.

Reservoir networks are also considered that consist entirely of a cycle or ring with identical weights with no attached tree structure, depicted in FIG. 9, as well as networks with a single line of nodes (a cycle that has been cut), depicted in FIG. 10. These are also known as simple cycle reservoirs and delay line reservoirs, respectively.

Thus, these five topologies are: general construction with unrestrained k (FIG. 6), k=1 with a single cycle (FIG. 7), k=1 with a cut cycle (FIG. 8), single cycle or simple cycle reservoir (FIG. 9), and single line or delay line reservoir (FIG. 10). Both the k=1 cut cycle networks (FIG. 8) and line networks (FIG. 10) are rescaled to have a fixed pr before the cycle is cut. However, after the cycle is cut, they both have ρᵣ=0. It has been determined that the delay line reservoir performs as well as the other reservoirs, once the delay line reservoir is optimized. Moreover, the delay line reservoir is much easier to realize in hardware.

FIG. 11 is block diagram of another implementation of a reservoir computing device 1100. The reservoir computing device 1100 can receive an input 1105, such as input u(t) from a memory 1120 or a computing device such as the computing device 1300 described with respect to FIG. 13. Depending on the implementation, the memory 1120 may be comprised within, or in communication with, the reservoir computing device 1100, comprised within the computing device 1300, or other suitable memory or storage device. In an embodiment, the device 1100 may comprise an FPGA, with each component of the device 1100 being implemented in the FPGA, although this is not intended to be limiting, as other implementations are contemplated, such as an Application Specific Integrated Circuit (ASIC), for example.

In an implementation, a controller 1110 may store data to and/or retrieve data from the memory 1120. The data may include the input 1105, an output 1155, and node data of a reservoir 1130. Data associated with testing and training may also be provided to and from the controller 1110 to and from a tester 1140 and a trainer 1150, respectively. The controller 1120 may be configured to apply weighting to the input 1105 and/or the output prior to being provided as the output 1155. The weightings may be generated by a weighting module 1160, provided to the controller 1110, and applied to the various signals by the controller 1110.

The reservoir 1130 may process the input 1105 and generate the output 1155. In some embodiments, output from the reservoir 1130 may be weighted by the controller 1110. The controller 1110 may then provide this weighted output of the reservoir 1130 as the output 1155.

An optimizer 1170 may determine and optimize hyperparameters as described further herein. For Bayesian optimization, the choice of hyperparameters that best fits this is difficult to identify. Grid search and gradient descent have been used previously. However, these algorithms struggle with either non-continuous parameters or noisy results. Because Wᵣ and Wᵢₙ are determined randomly, the optimization algorithm should be able to handle noise. In an implementation, Bayesian optimization may be implemented using the skopt (i.e., Scikit-Optimize) Python package. Bayesian optimization deals well with both noise and integer parameters like k, is more efficient than grid search, and works well with minimal tuning.

For each topology, the Bayesian algorithm repeatedly generates a set of hyperparameters to test within the ranges listed in Table 1, in some implementations. Larger ranges require a longer optimization time. These ranges may be selected (e.g., by a user or an administrator) to include the values that existing heuristics would choose, and to allow exploration of the space without a prohibitively long runtime. However, exploring outside these ranges is valuable. The focus here is on the connectivity k, but expanding the search range for the other parameters may also produce useful results.

TABLE 1
Range of hyperparameters searched using Bayesian optimization.

| Parameter | Min | Max |
|---|---|---|
| γ | 7 | 11 |
| σ | 0.1 | 1.0 |
| ρᵢₙ | 0.3 | 1.5 |
| k | 1 | 5 |
| ρᵣ | 0.3 | 1.5 |

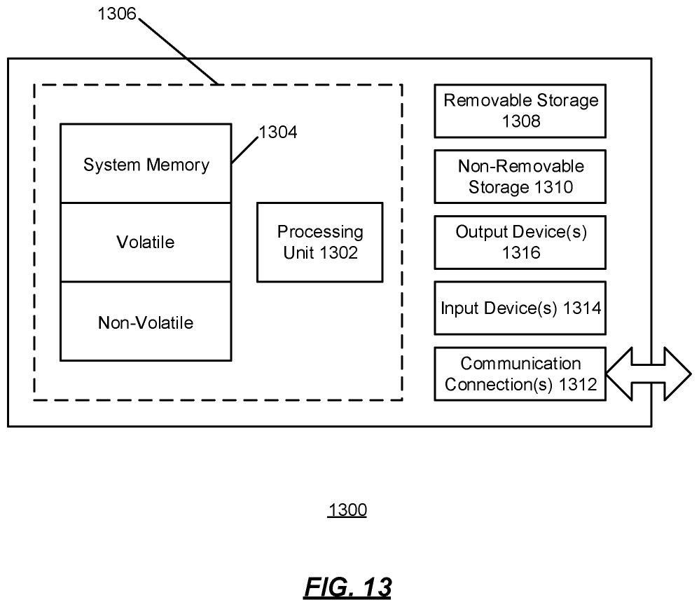

FIG. 12 is an operational flow of an implementation of a method 1200 of determining hyperparameters for reservoir computing.

At 1210, a set of hyperparameters are chosen. At each iteration of the algorithm, at 1220, the optimizer constructs a single random reservoir computer with the chosen hyperparameters. At 1230, the reservoir computer is trained according to the procedures described herein.

At 1240, the performance of the reservoir computer is measured using any known metric. From this measurement, at 1250 a new set of hyperparameters is chosen to test that may be closer to the optimal values. The number of iterations of this algorithm may be limited to test a maximum of 100 reservoir realizations before returning an optimized reservoir. In order to estimate the variance in the performance of reservoirs optimized by this method, this process may be repeated 20 times. At 1260, after 1220-1250 have been repeated the predetermined number of times, or until another event occurs that causes the iterations of 1220-1250 to cease (e.g., an optimization goal is met, a performance goal is met, etc.).

Regarding training, to train the RC, in an implementation, use t=0 to 300 with a fixed time step Δt=0.01, and divide this interval into three ranges: t=0 −100: a transient, which is discarded; t=100−200: the training period; and t=200−300: the testing period.

The transient period is used to ensure the later times are not dependent on the specific initial conditions. The rest is divided into a training period, used only during training, and a testing period, used later only to evaluate the RC performance.

This integration produces a solution for r(t). However, when the reservoir is combined with the Lorenz system, it has a symmetry that can confuse prediction. Before integration, this symmetry is broken by setting fₒᵤₜ so that, as shown, for example, by Equation (7):

$${\tilde{r}}_{i} ( t ) = \{ \begin{matrix}{r}_{i} ( t ) & if & i \leq N / 2 \\ {{r}_{i} ( t )}^{2} & if & i > N / 2\end{matrix} \qquad ( 7 )$$

This may be performed for every reservoir that is constructed. In the implementation of Equation (7), it is shown that 50% are linear and the other 50% are quadratic, but this is not intended to be limiting. It is noted that the fraction that is linear versus the fraction that is quadratic is a parameter than can be adjusted and optimized, depending on the implementation.

Then find a Wₒᵤₜ to minimize Equation (8):

Σ²⁰⁰ₜ₌100|U(t)−Wₒᵤₜ\tilde{r}(t)|²+α||Wₒᵤₜ||² (8)

where the sum is understood to be over time steps At apart. Now that Wont is determined, the RC is trained.

Equation 8 is known as Tikhonov regularization or ridge regression. The ridge parameter a could be included among the hyperparameters to optimize. However, unlike the other hyperparameters, modifying α does not require re-integration and can be optimized with simpler methods. Select an a from among 10⁻⁵ to 10⁵ by leave-one-out cross-validation. This also reduces the number of dimensions the Bayesian algorithm must work with.

FIG. 13 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 13, an exemplary system for implementing aspects described herein includes a computing device, such as computing device 1300. In its most basic configuration, computing device 1300 typically includes at least one processing unit 1302 and memory 1304. Depending on the exact configuration and type of computing device, memory 1304 may be volatile (such as random access memory (RAM)), non-volatile (such as read-only memory (ROM), flash memory, etc.), or some combination of the two. This most basic configuration is illustrated in FIG. 13 by dashed line 1306.

Computing device 1300 may have additional features/functionality. For example, computing device 1300 may include additional storage (removable and/or non-removable) including, but not limited to, magnetic or optical disks or tape. Such additional storage is illustrated in FIG. 13 by removable storage 1308 and non-removable storage 1310.

Computing device 1300 typically includes a variety of computer readable media. Computer readable media can be any available media that can be accessed by the device 1300 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1304, removable storage 1308, and non-removable storage 1310 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1300. Any such computer storage media may be part of computing device 1300.

Computing device 1300 may contain communication connection(s) 1312 that allow the device to communicate with other devices. Computing device 1300 may also have input device(s) 1314 such as a keyboard, mouse, pen, voice input device, touch input device, etc. Output device(s) 1316 such as a display, speakers, printer, etc. may also be included. All these devices are well known in the art and need not be discussed at length here.

In an implementation, a method of optimizing a topology for reservoir computing is provided, the method comprising: optimizing a plurality of reservoir computer (RC) hyperparameters to generate a topology; and creating a reservoir as a network of interacting nodes with the topology.

Implementations may include some or all of the following features. Optimizing the plurality of RC hyperparameters uses a Bayesian technique. The plurality of RC hyperparameters describe a reservoir network with extremely low connectivity. The reservoir has no recurrent connections. The reservoir has a spectral radius that equals zero. The plurality of RC hyperparameters comprise: γ, which sets a characteristic time scale of the reservoir; σ, which determines a probability a node is connected to a reservoir input; ρᵢₙ, which sets a scale of input weights; k, a recurrent in-degree of the network; and ρᵣ, a spectral radius of the network. The method further comprises selecting the plurality of RC hyperparameters by searching a range of values selected to minimize a forecasting error using a Bayesian optimization procedure. The topology is a single line. The reservoir is a delay line reservoir.

In an implementation, a method for optimizing a reservoir computer is provided, the method comprising: (a) constructing a single random reservoir computing using a plurality of hyperparameters; (b) training the reservoir computer; (c) measuring a performance of the reservoir computer; (d) choosing a second plurality of hyperparameters; (e) repeating (a)-(c) with the second plurality of hyperparameters to determine a set of optimized hyperparameters; and (f) creating a reservoir using the set of optimized hyperparameters.

Implementations may include some or all of the following features. The method further comprises choosing the plurality of hyperparameters prior to constructing the single random reservoir computer. Choosing the plurality of hyperparameters comprises selecting the plurality of hyperparameters by searching a range of values selected to minimize a forecasting error using a Bayesian optimization procedure. The method further comprises generating a topology using the set of optimized hyperparameters. Creating the reservoir using the set of optimized hyperparameters comprises creating the reservoir as a network of interacting nodes with the topology. The topology is a single line. The plurality of hyperparameters comprise: γ, which sets a characteristic time scale of a reservoir; σ, which determines a probability a node is connected to a reservoir input; ρᵢₙ, which sets a scale of input weights; k, a recurrent in-degree of a reservoir network; and ρᵣ, a spectral radius of the reservoir network. The method further comprises iterating (a)-(d) a predetermined number of times with different hyperparameters for each iteration.

In an implementation, a topology for creating a reservoir as a network is provided, wherein the topology is a single line.

Implementations may include some or all of the following features. The network consists entirely of a line. The reservoir is a delay line reservoir.

As used herein, the singular form “a,” “an,” and “the” include plural references unless the context clearly dictates otherwise.

As used herein, the terms “can,” “may,” “optionally,” “can optionally,” and “may optionally” are used interchangeably and are meant to include cases in which the condition occurs as well as cases in which the condition does not occur.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed.

It should be understood that the various techniques described herein may be implemented in connection with hardware components or software components or, where appropriate, with a combination of both. Illustrative types of hardware components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of optimizing a topology for reservoir computing, the method comprising:
optimizing a plurality of reservoir computer (RC) hyperparameters to generate a topology; and
creating a reservoir as a network of interacting nodes with the topology.

2. The method of claim 1, wherein optimizing the plurality of RC hyperparameters uses a Bayesian technique.

3. The method of claim 1, wherein the plurality of RC hyperparameters describe a reservoir network with extremely low connectivity.

4. The method of claim 1, wherein the reservoir has no recurrent connections.

5. The method of claim 1, wherein the reservoir has a spectral radius that equals zero.

6. The method of claim 1, wherein the plurality of RC hyperparameters comprise:
γ, which sets a characteristic time scale of the reservoir,
σ, which determines a probability a node is connected to a reservoir input,
ρᵢₙ, which sets a scale of input weights,
k, a recurrent in-degree of the network, and
ρᵣ, a spectral radius of the network.

7. The method of claim 1, further comprising selecting the plurality of RC hyperparameters by searching a range of values selected to minimize a forecasting error using a Bayesian optimization procedure.

8. The method of claim 1, wherein the topology is a single line.

9. The method of claim 1, wherein the reservoir is a delay line reservoir.

10. A method for optimizing a reservoir computer, the method comprising:
(a) constructing a single random reservoir computing using a plurality of hyperparameters;
(b) training the reservoir computer;
(c) measuring a performance of the reservoir computer;
(d) choosing a second plurality of hyperparameters;
(e) repeating (a)-(c) with the second plurality of hyperparameters to determine a set of optimized hyperparameters; and
(f) creating a reservoir using the set of optimized hyperparameters.

11. The method of claim 10, further comprising choosing the plurality of hyperparameters prior to constructing the single random reservoir computer.

12. The method of claim 11, wherein choosing the plurality of hyperparameters comprises selecting the plurality of hyperparameters by searching a range of values selected to minimize a forecasting error using a Bayesian optimization procedure.

13. The method of claim 10, further comprising generating a topology using the set of optimized hyperparameters.

14. The method of claim 13, wherein creating the reservoir using the set of optimized hyperparameters comprises creating the reservoir as a network of interacting nodes with the topology.

15. The method of claim 13, wherein the topology is a single line.

16. The method of claim 10, wherein the plurality of hyperparameters comprise:
γ, which sets a characteristic time scale of a reservoir,
σ, which determines a probability a node is connected to a reservoir input,
ρᵢₙ, which sets a scale of input weights,
k, a recurrent in-degree of a reservoir network, and
ρᵣ, a spectral radius of the reservoir network.

17. The method of claim 10, further comprising iterating (a)-(d) a predetermined number of times with different hyperparameters for each iteration.

18. A topology for creating a reservoir as a network, wherein the topology is a single line.

19. The topology of claim 18, wherein the network consists entirely of a line.

20. The topology of claim 18, wherein the reservoir is a delay line reservoir.
